(19) United States
(12) Patent Application Publication
(10) Pub. No.: US 2008/0177644 A1
(43) Pub. Date: Jul. 24, 2008

(54) Method and system of fractional telecommunications switch ownership

(75) Inventor: Christopher E. Reese, Houston, TX (US)

Correspondence Address: BRACEWELL & GIULIANI LLP, P.O. BOX 61389, HOUSTON, TX, 77208-1389, US

(73) Assignee: i3 Voice & Data, Inc.

(21) Appl. No.: 11/656,243

(22) Filed: Jan. 22, 2007

(51) Int. Cl. G06Q 30/00; H04M 7/00; G06Q 10/00

(52) U.S. Cl. 705/30; 379/242; 705/1

(57) ABSTRACT

Embodiments of the present invention provide for a method and system of fractional telecommunications switch ownership. In one embodiment, an ownership interest in a telecommunications switch is transferred to one or more third parties. In another embodiment, two or more third parties each hold an ownership interest in separate fractions of a telecommunications switch. In a further embodiment, an operator operates a telecommunications switch in which one or more third parties hold an ownership interest while the operator retains other ownership interests in the switch. Finally, a telecommunications network is provided as an example of telecommunications network operable with the invention.

### CROSS-REFERENCE TO RELATED APPLICATION

This non-provisional patent application claims the benefit under § 119(e) of U.S. Provisional Patent Application Ser. No. 60/720,466, filed Jan. 20, 2006, which is incorporated herein by reference.

### BACKGROUND OF THE INVENTION

1. Field of the Invention

This invention relates generally to telecommunications and, more specifically, to a method and system of fractional telecommunications switch ownership.

2. Description of Related Art

Competition was introduced into the long distance telecommunications market in 1982 as a result of the breakup of AT&T Corp. Local dial tone service was then deregulated in 1996, which brought competition to the local dial tone market. Under deregulation, a Competitive Local Exchange Carrier (CLEC) was able to access the network of an Incumbent Local Exchange Carrier (ILEC), such as SBC, Inc. or BellSouth Telecommunications, Inc., using the Unbundled Network Elements Platform (UNE-P). This arrangement provided CLECs with three main options for the provision of local dial tone: 1) private label ILEC packages; 2) purchase the last mile, port, and switch from an ILEC; or 3) operate as a fill facilities-based carrier by installing class-5 switching. Most CLECs chose the first two options due to capital limitations and apprehension caused by the failure of companies that build their own networks.

The Federal Communications Commission (FCC) announced on Dec. 15, 2004 that, following a 12-month grace period, ILECs would no longer have to provide access to their networks. CLECs, however, could still lease access to ILEC networks at much higher costs under commercially negotiated agreements. This situation left CLECs with three much less favorable options: shut down, drastically raise rates, or build a network. Most CLECs developed as marketing and billing companies due to the UNE-P arrangement following deregulation. Thus most CLECs lack the capital and knowledge to build and operate switching networks, and few CLECs want to operate their own switches.

Furthermore, under the now-defunct UNE-P arrangement or the commercially negotiated agreements now used, CLECs may only rent or lease a portion of a telecommunications switch. Thus the portion of a telecommunications switch used by a CLEC is not a bookable asset of the CLEC. This means that the CLEC cannot use the depreciation of the switch for tax purposes, which results in lower profits for the CLEC and higher prices for the CLEC's customers.

Any solution to the crisis facing CLECs would preferably provide CLECs with network access without renting or leasing from an ILEC and without the CLEC running its own network. Furthermore, a preferred solution would permit CLECs to realize the tax savings resulting from telecommunications switch depreciation.

### SUMMARY OF THE INVENTION

A telecommunications switch is partitioned into fractions. In a preferred embodiment the telecommunications switch is a Class 5 Softswitch and each fraction is a port. An ownership interest in each fraction is transferred to a third party. In a preferred embodiment a CLEC receives depreciation rights, buy-back rights, and transfer rights.

The telecommunications system of which the telecommunications switch is a part may be configured in any manner that permits partitioning of the switch. In a preferred embodiment, a Class 5 Softswitch communicates with a plurality of networks which in turn provide various services or access to other carriers. The switch of a preferred embodiment is partitioned through the use of software that allows the segregation of switch ports and CLEC subscriber information. In this way a single Class 5 Softswitch operates virtually as multiple switches.

In a preferred embodiment, an operator maintains, services, and monitors the switch in a fully secure carrier-class facility with redundant power, HVAC, and network access. The operator preferably also aggregates and segregates call details, segregates and validates call records, and provides other services of value to CLECs.

Embodiments of the present invention thus permit CLECs to share a network and capture the advantages of telecommunications switch ownership without actually operating a telecommunications switch or network.

### BRIEF DESCRIPTION OF THE DRAWINGS

Some of the features and benefits of the present invention having been stated, others will become apparent as the description proceeds when taken in conjunction with the accompanying drawings, in which:

FIG. 1 is a flow chart illustrating a method of operating a telecommunications switch.

FIG. 2 is a diagram illustrating a method of owning a telecommunications switch.

FIG. 3 is diagram illustrating a telecommunications network.

FIG. 4 is a diagram illustrating a system of telecommunications.

### DETAILED DESCRIPTION

The present invention now will be described more fully hereinafter with reference to the accompanying drawings in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

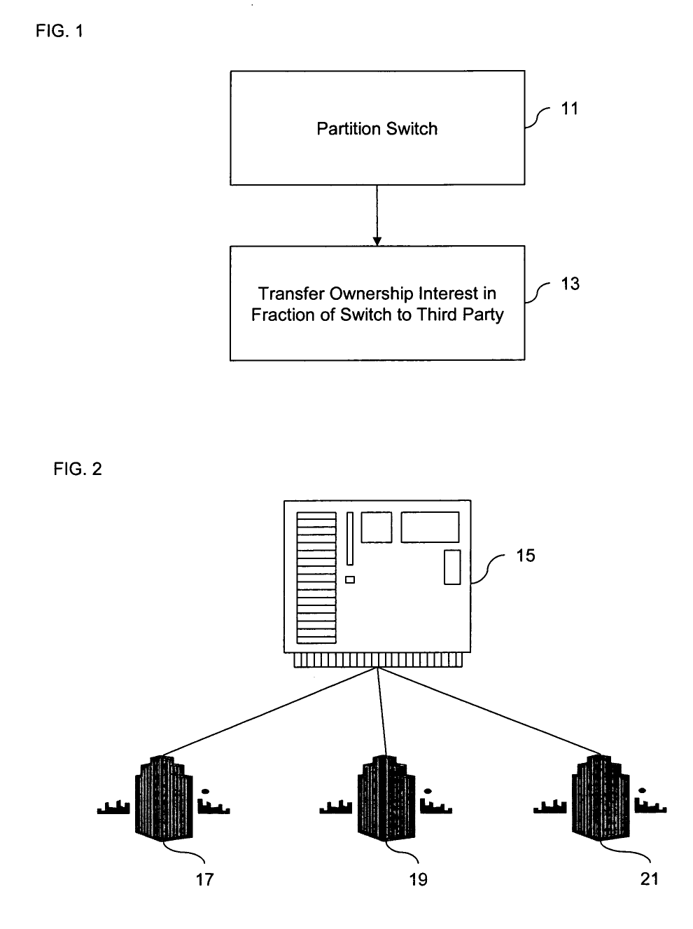

FIG. 1 illustrates a method of operating a telecommunications switch. In step 11 the switch is partitioned into a plurality of fractions. In a preferred embodiment a Class 5 Softswitch is partitioned through the use of software that allows the segregation of switch ports and CLEC subscriber information. Suitable partitioning software may be purchased from third parties or proprietary software can be used. A combination of third-party and proprietary software is used in a preferred embodiment. Although in a preferred embodiment a Class 5 Softswitch is partitioned into ports using software, all telecommunications switches, partitioning means, and switch fractions are within the scope of the invention.

In step 13 an ownership interest in one or more switch fractions is transferred to a third party. The transfer of ownership interests is preferably accomplished by means of a contract with the third party. Any type or number of ownership rights and obligations may be transferred to the third party, however, in a preferred embodiment, the ownership interests transferred may include depreciation rights, buy-back rights, and transfer rights. The depreciation rights of a preferred embodiment are based upon a percentage of all ports licensed by the third party as compared to the total number of switch ports. For example, if a third party receives an ownership interest in 3000 ports and the switch has 60,000 switch ports, the third party would receive a 5% depreciation right. The buy-back rights of the preferred embodiment permit a third party to sell back its interest in the ports during a particular time period for a particular price. The transfer rights of a preferred embodiment permit a third party to assign its interest in the ports to another third party under certain conditions such as, for example, prior approval.

The third party to which an ownership interest in the switch is transferred is preferably a CLEC. However, any third party wishing to own a portion of a telecommunications switch could act as the third party. Examples include corporations, universities, and government entities.

FIG. 2 illustrates a method of owning a telecommunications switch. Telecommunications switch 15 has a plurality of fractions. In a preferred embodiment each fraction is a port, but the switch could be partitioned in other ways. An ownership interest, such as depreciation rights, buy-back rights, or transfer rights, is held by one or more third parties 17, 19, 21. Three third parties are depicted in FIG. 2. However, one of skill in the art would understand that this number is only an example, and that the scope of the inventions includes any method wherein one or more third parties hold an ownership interest in fractions of the switch. Each third party is preferably a CLEC and each CLEC preferably holds an ownership interest in one or more ports, but two CLECs would preferably not hold an ownership interest in the same port.

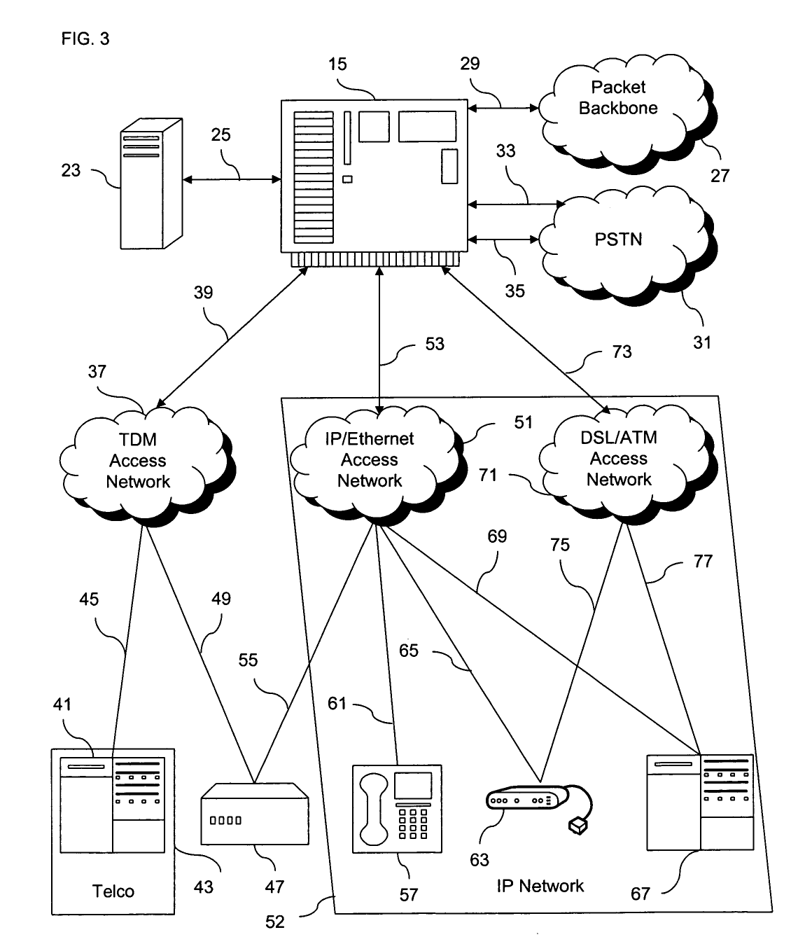

FIG. 3 illustrates a telecommunications system operable with the invention. The telecommunications system of FIG. 3 is only an example, and those of skill in the art will recognize that a telecommunications system arranged in any number of ways is operable with the invention. Telecommunications switch 15 is a Class 5 Softswitch partitioned into a plurality of fractions, each fractions preferably being a port. Switch 15 communicates with application server 23 via Session Initiation Protocal (SIP) connection 25. Application server 23 provides services such as unified messaging. Switch 15 also communicates with Packet Backbone 27 via SIP connection 29. Switch 15 further communicates with Public Switched Telephone Network (PSTN) 31 via two connections. The first connection is Signaling System 7 (SS7)/Multiple Frequency (MF) connection 33. The second connection is Time Division Multiplexing (TDM) T1/T3 connection 35.

Switch 15 additionally communicates with TDM Access Network 37 via TDM T1/T3 connection 39. TDM Access Network 37 communicates with Digital Loop Carrier 41, which is part of major telecommunications company 43, via GR-303 connection 45. TDM Access Network 37 further communications with Private Branch Exchange (PBX) 47 via T1/Primary Rate Interface (PRI) connection 49.

Switch 15 also communicates with Internet Protocol (IP)/Ethernet Access Network 51, part of IP Network 52, via Voice over IP (VoIP) Gigabit per second Ethernet (GigE) connection 53. IP/Ethernet Access Network 51 communicates with PBX 47 via VoIP connection 55. IP Ethernet Access Network 51 further communicates with IP phone 57, part of IP Network 52, via VoIP connection 61. IP/Ethernet Access Network 51 also communicates with device 63, which could be an Analog Telephone Adaptor (ATA), Integrated Access Device (IAD), or a cable Multimedia Terminal Adaptor, via VoIP connection 65. Device 63 is part of IP Network 52. IP Ethernet Access Network 51 further communicates with Broadband Loop Carrier 67, part of IP Network 52, via VoIP connection 69.

Switch 15 further communicates with Digital Subscriber Line (DSL)/Asynchronous Transfer Mode (ATM) Access Network 71, part of IP Network 52, via Voice over ATM (VoATM) Otical Carrier 3 (OC3) connection 73. DSL/ATM Access Network 71 communicates with device 63 via VoATM connection 75. DSL/ATM Access Network 71 also communicates with Broadband Loop Carrier 67 via VoATM connection 77.

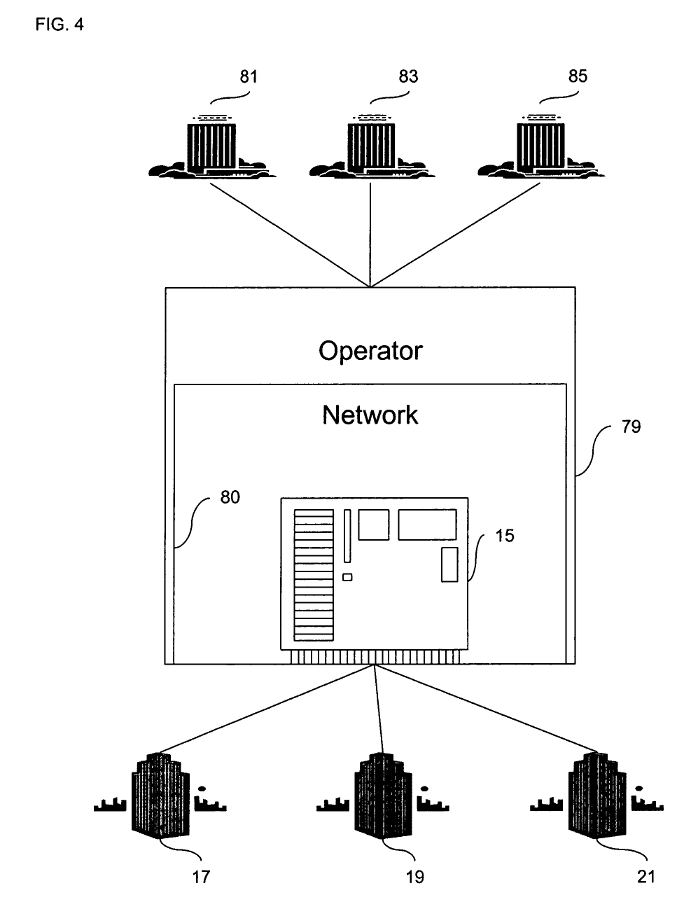

FIG. 4 illustrates a system of telecommunications. Telecommunications switch 15 is owned in part and operated by operator 79. In a preferred embodiment, the switch is part of telecommunications network 80 also operated by operator 79. Telecommunications switch 15 has a plurality of fractions. In a preferred embodiment each fraction is a port, but the switch could be partitioned in other ways. Ownership interests, such as depreciation rights, buy-back rights, or transfer rights, are held by one or more third parties 17, 19, 21. Ownership interests in switch 15 not held by third parties are retained by operator 79. Three third parties are depicted in FIG. 4. However, one of skill in the art would understand that this number is an example, and that the scope of the inventions includes any method wherein one or more third parties hold an ownership interest in fractions of a telecommunications switch. Each third party is preferably a CLEC and each CLEC preferably holds an ownership interest in one or more ports, but two CLECs would preferably not hold an ownership interest in the same port.

In a preferred embodiment telecommunications switch 15 is initially owned in whole by operator 79. Operator 79 then transfers an ownership interest in one or more ports of switch 15 to one or more third parties 17, 19, 21. The ownership interests not transferred to one or more third parties are retained by operator 79. If an ownership interest in switch 15 is transferred to only one third party, then operator 79 preferably would not transfer an ownership interest in every port of switch 15 to the third party.

Operator 79 works with vendors 81, 83, 85. Three vendors are depicted in FIG. 4. However, one of skill in the art would understand that this number is an example, and that the scope of the inventions includes any number of vendors. Each vendor preferably provides services to operator 79. Services provided by vendors 81, 83, 85 could include, by way of example, messaging, 911, 411, telephone operator services, directory listing, end office access, and billing. Third parties 17, 19, 21 do not work directly with vendors 81, 83, 85, but preferably obtain through operator 79 the benefit of one or more services provided by the vendors.

Operator 79 preferably provides one or more services to third parties 17, 19, 21. For example, the services provided by the operator could include: 1) hosting switch 15 in a fully secure carrier-class facility with redundant power, HVAC, and network access; 2) monitoring telecommunications network 80 at all times by a fully secured network operations center; 3) monitoring and insuring compliance of vendors 81, 83, 85 with agreements made between the vendors and operator 79, 4) monitoring and managing traffic on telecommunications network 80; 5) aggregating and segregating call detail records; 6) making call record details available via a secure FTP site; 7) aggregating and auditing vendor 81, 83, 85 billing; 8) segregating call records from vendors 81, 83, 85 and validating the call records against switch records; 9) providing interoperability supervision between vendor networks and operator's telecommunications network 80; 10) providing second tier trouble support for network issues and a web-based trouble ticket reporting and administration system; and 11) providing a network asset management system available through a we interface that allows third parties 17, 18, 21 to monitor and track network assets and their utilization.

In the drawings and specification, there have been disclosed embodiments of the invention and, although specific terms are employed, they are used in a generic and descriptive sense only and not for the purpose of limitation, the scope of the invention being set forth in the following claims.

That claimed is:

1. A method of operating a telecommunications switch comprising the steps of:
partitioning the switch into a plurality of fractions; and
transferring an ownership interest in one or more of the fractions to a third party.

2. The method of claim 1, wherein an ownership interest in less than all of the fractions of the switch is transferred.

3. The method of claim 1, wherein an ownership interest in one or more fractions of the switch is transferred to a first third party and an ownership interest in one or more different fractions of the switch is transferred to a second third party.

4. The method of claim 1, wherein the telecommunications switch is a Class 5 Softswitch.

5. The method of claim 1, wherein each fraction of the switch is a port.

6. The method of claim 1, wherein the third party is a Competitive Local Exchange Carrier.

7. The method of claim 1, wherein the ownership interest is selected from the group consisting of depreciation rights, buy-back rights, and transfer rights.

8. The method of claim 1, wherein the partitioning and transferring steps are performed by an operator.

9. A method of telecommunications switch ownership comprising the steps of:
partitioning a telecommunications switch into a plurality of fractions; and
transferring on ownership interest in one or more of the fractions to a third party.

10. The method of claim 9, wherein an ownership interest in less than all of the fractions of the switch is transferred.

11. The method of claim 9, wherein an ownership interest in one or more fractions of the switch is transferred to a first third party and an ownership interest in one or more different fractions of the switch is transferred to a second third party.

12. The method of claim 9, wherein the telecommunications switch is a Class 5 Softswitch.

13. The method of claim 9, wherein each fraction of the switch is a port.

14. The method of claim 9, wherein the third party is a Competitive Local Exchange Carrier.

15. The method of claim 9, wherein the ownership interest is selected from the group consisting of depreciation rights, buy-back rights, and transfer rights.

16. The method of claim 9, wherein ownership interests in the switch not transferred to a third party are retained by an operator.

17. A method of owning a telecommunications switch having a plurality of fractions comprising the step of:
holding an ownership interest in one or more, but less than all, fractions of the switch.

18. The method of claim 17, wherein an ownership interest in one or more fractions of the switch is held by a first party and an ownership interest in one or more different fractions of the switch is held by a second party.

19. The method of claim 17, wherein the telecommunications switch is a Class 5 Softswitch.

20. The method of claim 17, wherein each fraction of the switch is a port.

21. The method of claim 17, wherein the ownership interest is held by a Competitive Local Exchange Carrier.

22. The method of claim 17, wherein the ownership interest is selected from the group consisting of depreciation rights, buy-back rights, and transfer rights.

23. A system of telecommunications comprising:
a telecommunications switch having a plurality of fractions; and
two or more parties each having an ownership interest in one or more different fractions of the telecommunications switch.

24. The system of claim 23, wherein the telecommunications switch is a Class 5 Softswitch.

25. The system of claim 23, wherein each fraction of the switch is a port.

26. The system of claim 23, wherein each third party is a Competitive Local Exchange Carrier.

27. The system of claim 23, wherein the ownership interest is selected from a group consisting of depreciation rights, buy-back rights, and transfer rights.

28. A system of telecommunications comprising:
a telecommunications switch, the switch having a plurality of fractions;
a telecommunications network including the telecommunications switch;
an operator that operates the switch and network; and
one or more third parties that hold an ownership interest in one or more fractions of the switch.

29. The system of claim 28, further comprising one or more vendors that provide services to the operator.

30. The system of claim 28, wherein ownership interests not held by the one or more third parties are held by the operator.

31. The system of claim 28, wherein the operator provides one or more services to the one or more third parties.

32. The system of claim 28, wherein the telecommunications switch is a Class 5 Softswitch.

33. The system of claim 28, wherein each fraction of the switch is a port.

34. The system of claim 28, wherein each third party is a Competitive Local Exchange Carrier.

35. The system of claim 28, wherein the ownership interest is selected from the group consisting of depreciation rights, buy-back rights, and transfer rights.
